(19) United States
(12) Patent Application Publication
(10) Pub. No.: US 2026/0296369 A1
(43) Pub. Date: Oct. 1, 2026

(54) HANDLING ENDURING ACTION USING AN ANCHOR SYSTEM OF VEHICLE

(71) Applicant: Cypress Semiconductor Corporation, San Jose, CA (US)

(72) Inventors: Vivekanandh Elangovan, Canton, MI (US); Ajinder Pal Singh, Allen, TX (US); Victor Zhodzishsky, Potomac, MD (US)

(73) Assignee: Cypress Semiconductor Corporation, San Jose, CA (US)

(21) Appl. No.: 19/310,344

(22) Filed: Aug. 26, 2025

Related U.S. Application Data
(60) Provisional application No. 63/781,876, filed on Apr. 1, 2025.

(51) Int. Cl. B60R 25/24

(52) U.S. Cl. CPC B60R 25/24; B60R 2325/101; B60R 2325/205

(57) ABSTRACT

A method, a computing apparatus, and an anchor system are provided. The anchor system includes a central anchor and an secondary anchor. The central anchor is connected to a first wireless device and a second wireless device. The central anchor is configured to determine that the first wireless device has initiated an enduring action. The central anchor is also configured to process data of the enduring action. Responsive to processing the data of the enduring action, the central anchor is configured to disconnect from the second wireless device. The secondary anchor is configured to establish a connection with the second wireless device.

### CROSS REFERENCE TO RELATED APPLICATIONS

This application claims priority to U.S. Provisional Patent Application No. 63/781,876, filed on Apr. 1, 2025, the content of which is incorporated herein by reference.

### TECHNICAL FIELD

The present disclosure relates generally to vehicle operation control, and more particularly, to handling an enduring action using an anchor system of a vehicle.

### BACKGROUND

Motor vehicles are often equipped with wireless communication modules to wirelessly connect the vehicles to user devices, such as key fobs and mobile phones. Through wireless connection, a user, at a distance from a vehicle, can remotely control the vehicle to perform a variety of operations, such as opening or locking a door, activating or deactivating the vehicle motor or engine, or moving into or away from a parking spot.

### BRIEF DESCRIPTION OF THE DRAWINGS

The present disclosure is illustrated by way of example, and not by way of limitation, in the figures of the accompanying drawings in which like reference numerals refer to similar elements.

FIG. 1 illustrates a vehicle having an anchor system, according to some implementations.

FIG. 2 illustrates a block diagram of an anchor system operatively coupled to a host microcontroller (MCU), according to some implementations.

FIG. 3 illustrates connections between a host MCU, an anchor system and a plurality of wireless devices, according to some implementations.

FIG. 4 is a flowchart that illustrates the handling of an enduring action using an anchor system of a vehicle, according to some implementations.

FIG. 5 is a block diagram of a BLUETOOTH module of an anchor system, according to some implementations.

FIG. 6 is a flowchart of an example method, according to some implementations.

FIG. 7 is a block diagram of an example apparatus that may perform one or more of the operations described herein, according to some implementations.

### DETAILED DESCRIPTION

The following description sets forth numerous specific details such as examples of specific systems, components, methods, and so forth, in order to provide a good understanding of various implementations of the techniques described herein. It will be apparent to one skilled in the art, however, that at least some implementations may be practiced without these specific details. In other instances, well-known components, elements, or methods are not described in detail or are presented in a simple block diagram format in order to avoid unnecessarily obscuring the techniques described herein. Thus, the specific details set forth hereinafter are merely exemplary. Particular implementations may vary from these exemplary details and still be contemplated to be within the scope of the present disclosure.

Some vehicles are capable of performing operations under the control of a remote wireless device. For example, a vehicle may perform automatic parking in response to a wireless signal transmitted from a mobile phone or a key fob with a digital key installed thereon. Depending on the time to complete the operation, some operations are referred to as enduring actions because it generally takes the vehicle relatively long time, e.g., from a fragment of one second to tens of seconds, to process the instruction from the remote wireless device and complete the operation. In some cases, an enduring action is performed over a connection interval of about 30 milliseconds (ms) during which the vehicle and the remote wireless device exchange data, and a processing delay may result in a failure of completing the enduring action. Additionally, sometimes the vehicle may receive a message, such as a remote keyless entry (RKE) message, from another remote wireless device that also has a digital key installed thereon. To validate and execute the message, the vehicle may have to interrupt, e.g., suspend, the enduring action, potentially resulting in unsatisfactory user experience and safety risk. Accordingly, it is desirable for the vehicle to handle the validation and processing of the message without unnecessarily delaying or interrupting the enduring action.

This disclosure provides techniques that address the challenges described above. As described in detail below, implementations of this disclosure allow a vehicle to process the enduring action with a remote wireless device using a central anchor while maintaining connections with other wireless devices using secondary (e.g., exterior) anchors. In the event of receiving a message, a secondary anchor determines the priority of the message and retains any low-priority message (e.g., a message that does not require immediate execution by the central anchor) until the central anchor completes processing the enduring action. With the features described below, implementations of this disclosure avoid unnecessary interruptions of the enduring action, thereby improving vehicle performance and improve user experience.

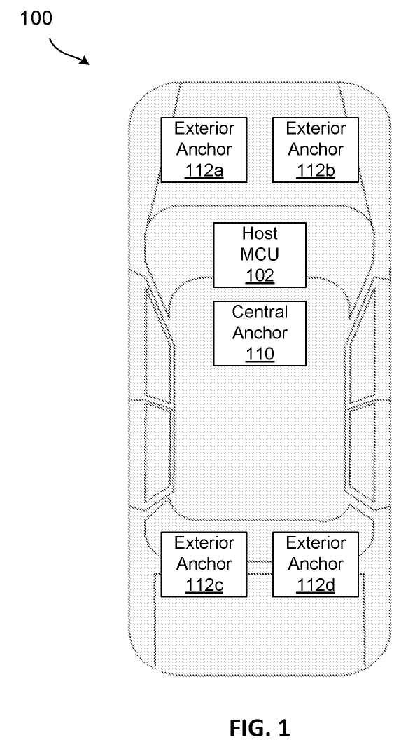

FIG. 1 illustrates a vehicle 100 having an anchor system, according to some implementations. As illustrated, vehicle 100 includes host MCU 102 operatively coupled to an anchor system that includes central anchor 110 and secondary anchors 112a-112d (collectively referred to as secondary anchors 112 and individually referred to as secondary anchor 112).

Host MCU 102 includes a computing apparatus, such as a processing system with one or more processors, configured to execute instructions to control the operations of various parts of vehicle 100. In some implementations, host MCU 102 is or is included in an electronic control unit (ECU) of vehicle 100. In some other implementations, host MCU 102 is implemented on a computer separate from the ECU.

Each of central anchor 110 and secondary anchors 112 is an anchor device, which includes a wireless transceiver and a processing system configured to communicate and process data in one or more wireless protocols, such as BLUETOOTH, BLUETOOTH LOW ENERGY (BLE), and ULTRA-WIDEBAND (UWB). Central anchor 110, also referred to as central module 110 or central 110, is configured to process signals for, e.g., localization and security authentication. For example, based on an instruction from a remote wireless device, central anchor 110 performs UWB ranging and controls vehicle 100 to move autonomously into or out from a parking space. Central anchor 110 may also serves as a gateway between secondary anchors 112 and host MCU 102 and validates any potential security threats in the data received by secondary anchors 112.

In some implementations, central anchor 110 is integrated with an ECU of vehicle 100 or physically located in the same chamber of the ECU. On the other hand, secondary anchors 112 may be located at other locations of vehicle 100. In some implementations, an secondary anchor 112 is located outside the vehicle 100, e.g., at a parking meter, and joins the anchor system wirelessly when vehicle 100 is within a proximity. Each of secondary anchors 112 is equipped with a wireless communication module (e.g., circuit) of a protocol and is configured to monitor, e.g., via packet sniffing, the communications under the protocol between remote wireless devices and central anchor 110. For example, one or more of secondary anchors 112 are configured to perform BLE sniffing on the BLE connection between a remote wireless device and central anchor 110 and report the received signal strength indicator (RSSI) obtained from the sniffing to central anchor 110. Central anchor 110 thus can perform a localization function to determine the location of the remote wireless device based on the RSSI(s) reported by secondary anchors 112.

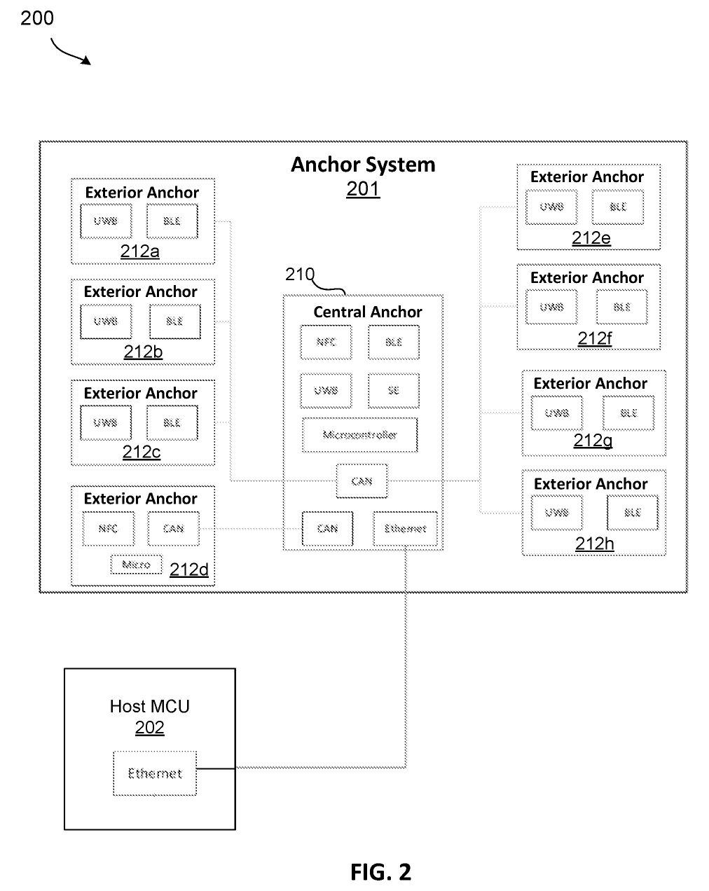

FIG. 2 illustrates a block diagram 200 of an anchor system 201 operatively coupled to a host MCU 202, according to some implementations. Host MCU 202 may be similar to host MCU 102 of FIG. 1, and anchor system 201, which includes central anchor 210 and secondary anchors 212a-212a (collectively referred to as secondary anchors 212) may be similar to the anchor system of vehicle 100 of FIG. 1.

As illustrated, host MCU 202 is coupled to anchor system 201, in particular central anchor 210 of anchor system 201, via ETHERNET, although other forms and protocols of connection are possible in other implementations. Through this connection, host MCU 202 may allocate tasks, such as data communication and processing, to central anchor 210 and secondary anchors 212, and may instruct vehicle components to perform various operations based on the processed data.

As further illustrated, central anchor 210 includes circuits (e.g., chipsets) corresponding to a plurality of technologies, such as near-field communication (NFC), BLE, UWB, and secure element (SE). Using an MCU, central anchor 210 is able to communicate with remote wireless device and preform security authentication on the communicated data. Central anchor 210 also includes circuits that manage data exchange via ETHERNET and controller area network (CAN) buses, which anchor system 201 uses to connect the anchor devices with one another and to connect with host MCU 202.

Similar to central anchor 210, each of secondary anchors 212 includes circuits corresponding to one or more technologies, such as BLE, UWB, and NFC. Some of secondary anchors 212 may include an MCU and circuits that manage data exchange via ETHERNET or CAN.

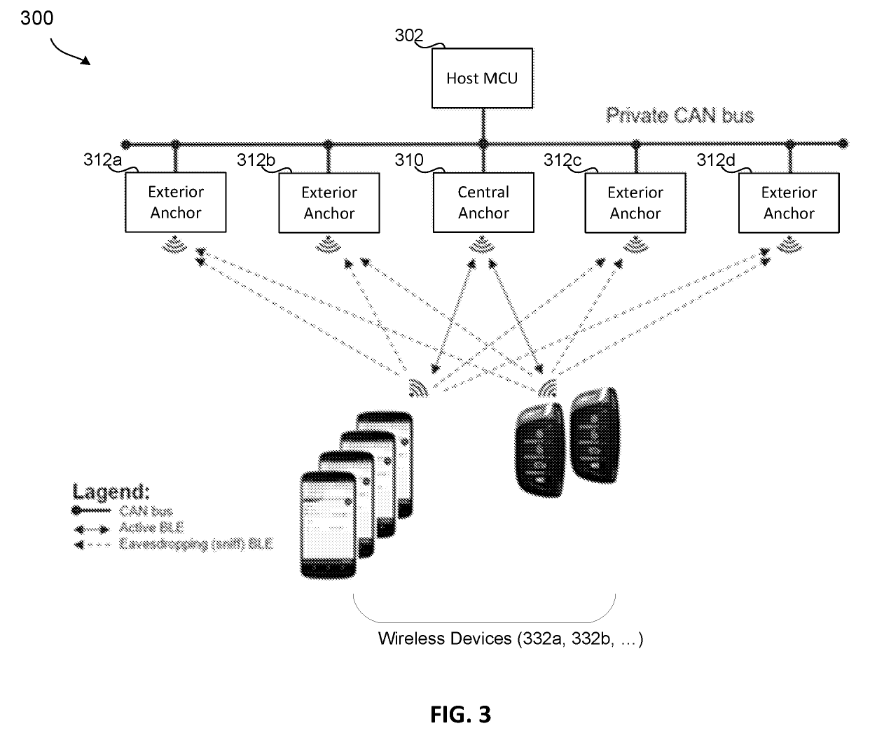

FIG. 3 illustrates connections 300 between a host device, an anchor system, and a plurality of wireless devices, according to some implementations. Host device 302 in FIG. 3 may include or be similar to host MCU 102 of FIG. 1 or host device 202 of FIG. 2. The anchor system, which includes central anchor 310 and a plurality of secondary anchors 312a-312d (collectively referred to as secondary anchors 312) may be similar to secondary anchors 112 of FIG. 1 or secondary anchors 212 of FIG. 2.

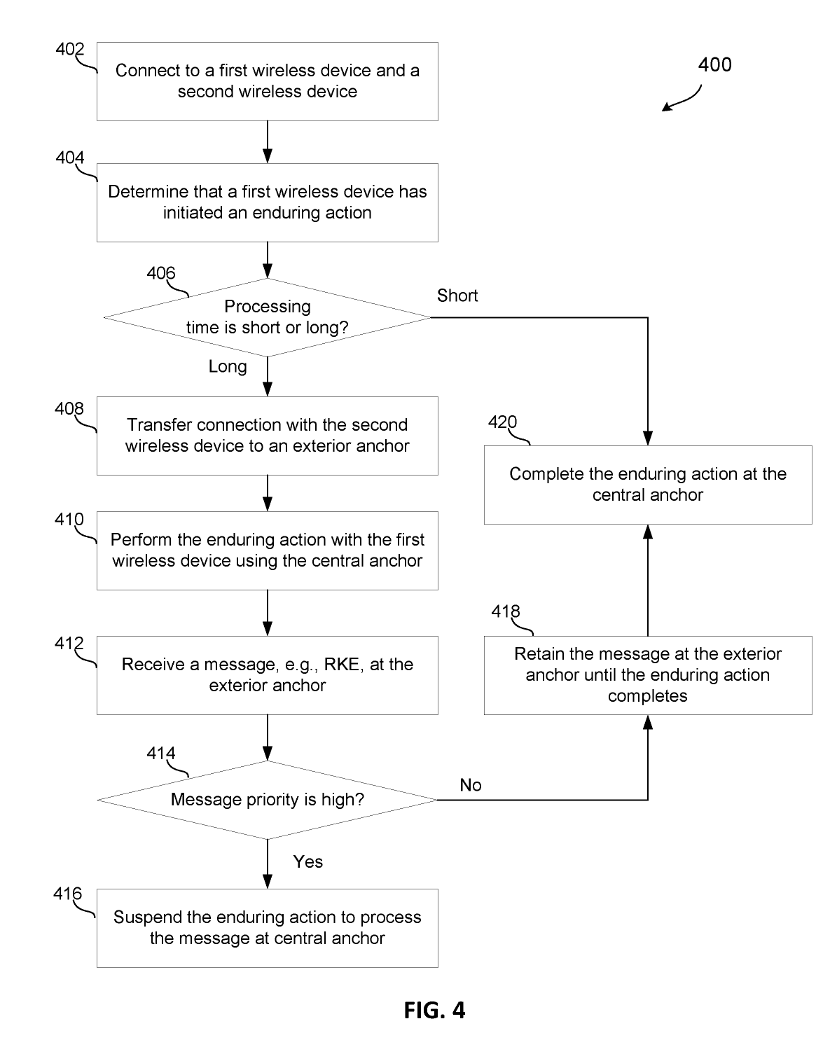

As illustrated, host MCU 302 is operatively connected to central anchor 310 and secondary anchors 312a-312d via a private CAN bus (e.g., a CAN bus that connects device in a private network) or alternatively an ETHERNET cable. In alternative implementations, host device 302 is implemented internal to central anchor 310. Central anchor 310 is connected to a plurality of remote wireless devices including a first remote wireless device 332a and a second remote wireless devices 332b, e.g., via active BLE sessions. Remote wireless devices 332a and 332b may include, e.g., a mobile phone, a key fob, a computer, etc. Through a respective session, each of remote wireless devices 332a and 332b can instruct central anchor 310 to perform an enduring action and can send RKE and other types of messages to central anchor 310. Meanwhile, each of secondary anchors 312a-312d is configured to monitor the connections between central anchor 310 and remote wireless devices 332a and 332b and reports signal strength, such as RSSI, for central anchor 310 to perform localization with the corresponding remote wireless device. Host MCU 302, central anchor 310, and secondary anchors 312a-312d together perform operations to handle the processing of a received message while an enduring action is ongoing, as described below with reference to FIG. 4.

FIG. 4 is a flowchart that illustrates a method 400 for handling an enduring action using an anchor system of a vehicle, according to some implementations. Method 400 may be performed by a vehicle computer, such as a host MCU alone or jointly with an anchor system or a central anchor of the anchor system.

At 402, method 400 involves connecting to a first wireless device and a second wireless device. For example, a central anchor, such as central anchor 310, connects to remote wireless devices 332 via respective BLE sessions, as described with reference to FIG. 3.

At 404, method 400 involves determining, e.g., by a host MCU or a central anchor, that a first wireless device has initiated an enduring action. The determination may be based on the data transmitted to the central anchor from the first wireless device, which may be one of remote wireless devices 332. For example, a user of a mobile device may instruct, via an application on the mobile device, a vehicle to move into a parking space. The central anchor of the vehicle receives the instruction in a wireless signal and actives UWB ranging functions for the parking operation accordingly.

At 406, method 400 involves determining whether the enduring action processing time is short or long. In some implementations, the vehicle computer or the central anchor processes the data of the enduring action, determines the type of the enduring action, estimates the processing time, and compares the estimated processing time with a threshold. For example, remote parking, tailgate opening and closing, and emergency alerting operations may be classified as long enduring actions due to the relatively long duration for performing or completing these operations. Conversely, locking and unlocking a vehicle door may be classified as short enduring actions due to the relatively short duration.

If the enduring action is determined to be a long operation, method 400 proceeds to 408 at which the central anchor transfers the connection with a second wireless device, e.g., the wireless device that did not activate the enduring action, to a secondary anchor. For example, the central anchor disconnects from the second wireless device and controls the secondary anchor to establish the connection with the second wireless device. The central anchor may transfer the connection with the second wireless device autonomously or at the direction of the host MCU via a CAN bus. After the transfer, the secondary anchor establishes a connection, e.g., an active BLE session, with the second wireless device based on the context of connection before the transfer, such that the pre-transfer connection with the second wireless device is maintained. Meanwhile, the central anchor suspends the transferred connection or disconnects from the second wireless device. Conversely, if the enduring action is determined to be a short operation, method 400 proceeds to 420 at which the central anchor completes the enduring action without interruption. In other words, even if a message is received in the middle of the short enduring action, central anchor still completes the enduring action first without being interrupted by the received message.

At 410, method 400 involves performing the enduring action with the first wireless device using the central anchor. In some implementations, the central anchor communicates data with the first wireless device and provide received data and instructions for the enduring action to a host MCU, which controls vehicle parts as instructed.

At 412, method 400 involves receiving a message, such as an RKE message, at the secondary anchor to which the connection with the second wireless device has been transferred. The secondary anchor may validate the message, e.g., to verify that the message was sent from an authorized sender.

At 414, method 400 involves determining the priority of the message, which may be set by an original equipment manufacturer (OEM), by an owner of the vehicle, or by another party or device. In some implementations, the secondary anchor determines the priority alone or jointly with the host MCU. In some implementations, the secondary anchor sends the message or a part of the message to the host MCU, which determines the priority and indicates the priority to the secondary anchor.

If the message priority is high, e.g., indicating that the message requires immediate processing despite the ongoing enduring action, then the secondary anchor sends the message, directly or via the host MCU, to the central anchor. Correspondingly, at 416, method 400 involves the central anchor suspending the enduring action and processing the message.

Conversely, if the message priority is low, then method 400 proceeds to 418 at which the secondary anchor retains the message until the enduring action completes. After the enduring action completes, the secondary anchor sends the message to the central anchor for processing, as described above with respect to 420.

According to the operations of method 400, implementations of this disclosure provide a mechanism to resolve a conflict between an ongoing enduring action and a message received during the enduring action. On one hand, the implementations allow short enduring actions to complete regardless of received messages and allow long enduring actions to proceed uninterrupted when the received messages have low priority. On the other hand, the implementations allow a secondary anchor to send the high priority messages to the central anchor for immediate processing. A host MCU, an anchor system, or other computing apparatuses of a vehicle may flexibly define the processing time threshold for classifying an enduring action as long versus short, and define the priority level threshold for classifying a received message as high priority versus low priority. Accordingly, a vehicle according to implementations of this disclosure improves user experience, vehicle safety, and control flexibility.

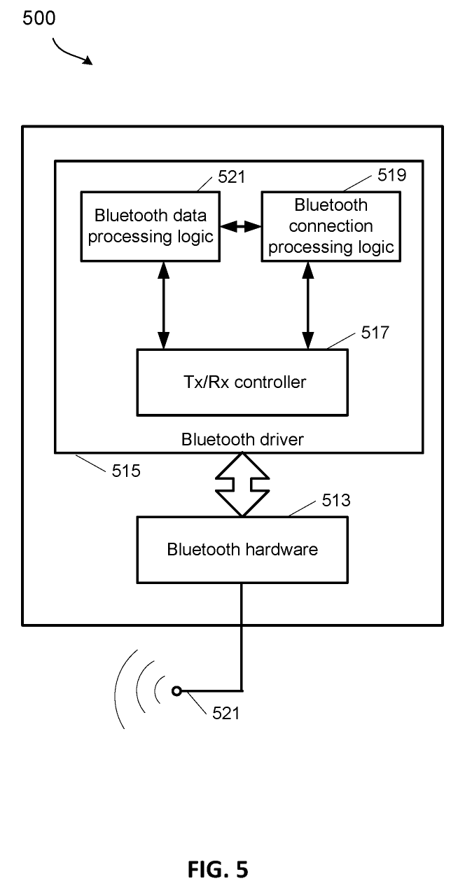

FIG. 5 is a block diagram of a BLUETOOTH module 500 of an anchor system, according to some implementations. Module 500 may be implemented by a central anchor or a secondary anchor for communicating with remote devices, as described above with reference to FIGS. 1-4.

As illustrated, module 500 includes one or more antennas 521, BLUETOOTH hardware 513 and BLUETOOTH driver 515. BLUETOOTH driver 515 may include BLUETOOTH transmit/receive (Tx/Rx) controller 517, BLUETOOTH data processing logic 521, and BLUETOOTH connection processing logic 519. BLUETOOTH hardware 513 may be configured to transmit or receive BLUETOOTH or BLE packets on an operating channel through the antennas 521.

BLUETOOTH Tx/Rx controller 517 may be configured to demodulate and decode received data packets and to encode and modulate data packets for transmission. BLUETOOTH data processing logic 521 may be configured to process the BLUETOOTH data to validate messages from remote devices and process instructions for performing various vehicle functions. BLUETOOTH connection processing logic 519 may be configured to establish or disconnect BLUETOOTH sessions, e.g., when the central anchor transfers a connection to a secondary anchor.

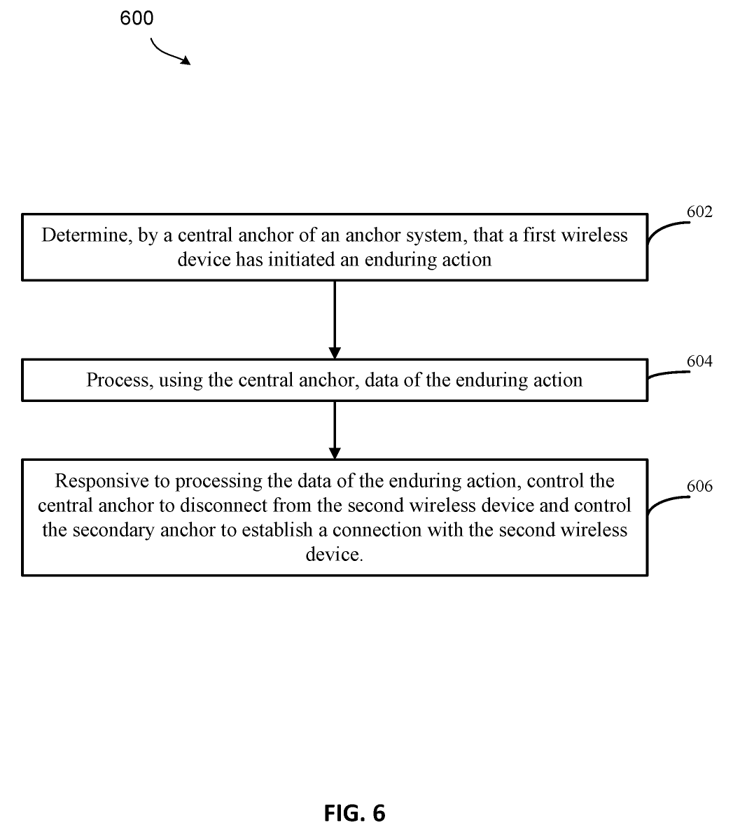

FIG. 6 is a flowchart of an example method 600, according to some implementations. Method 600 may be performed by a central anchor, a host MCU, or another computing device. Method 600 may correspond to some operations described above with reference to FIG. 4

At 602, method 600 involves determining, by a central anchor of an anchor system, that a first wireless device has initiated an enduring action. The central anchor may determine the initiation of the enduring action based on a BLUETOOTH message from the first wireless device that instructs a vehicle to perform the enduring action.

At 604, method 600 involves processing data of the enduring action using the central anchor. In some implementations, the central anchor processes the data by determining whether a processing time of the enduring action meets or exceeds a threshold. If the processing time meets or exceeds the threshold, the central anchor considers the processing time long; otherwise, the central anchor considers the processing time short.

At 606, method 600 involves controlling the central anchor to disconnect from the second wireless device and controlling the secondary anchor to establish a connection with the second wireless device. The control of the central anchor and the secondary anchor is responsive to the processing the data of the enduring action, e.g., responsive to determining that the enduring action has a long processing time.

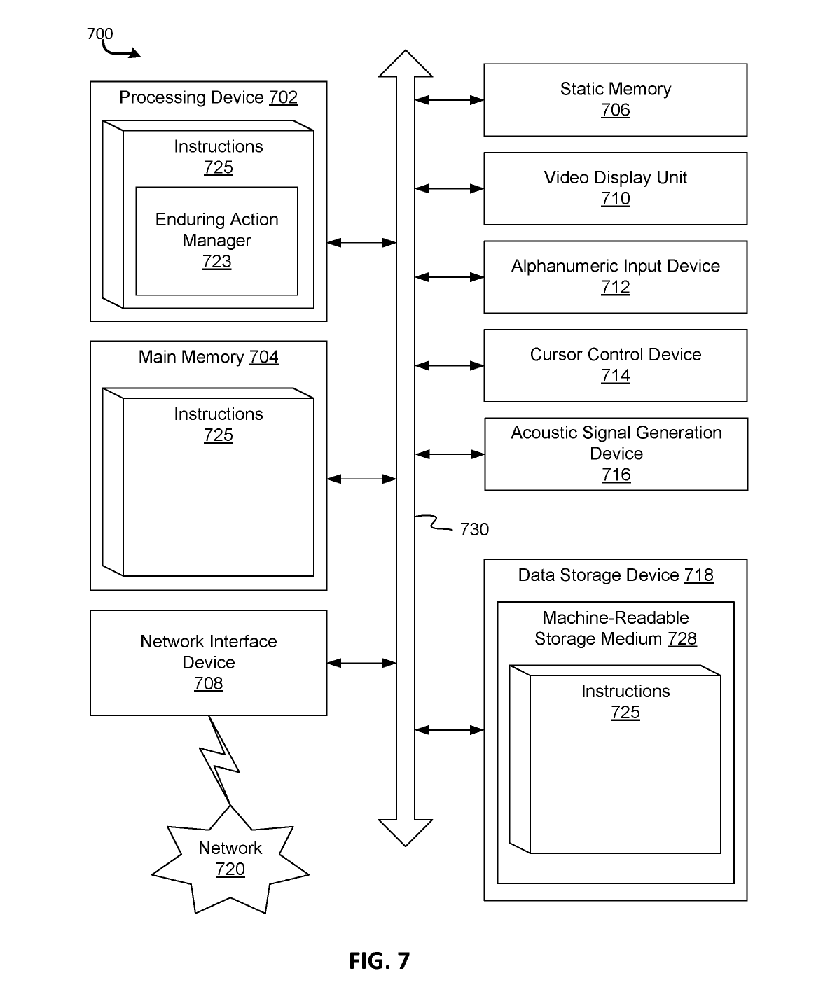

FIG. 7 is a block diagram of an example apparatus 700 that may perform one or more of the operations described herein, according to some implementations. Apparatus 700 may be implemented as a computing apparatus, such as an on-board computer on vehicle 101 of FIG. 1. Apparatus 700 may also be referred to as computing device 700.

Computing device 700 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 700 may include a processing device (e.g., a general purpose processor, a PLD, etc.) 702, a main memory 704 (e.g., synchronous dynamic random access memory (DRAM), read-only memory (ROM)), a static memory 706 (e.g., flash memory and a data storage device 718), which may communicate with each other via a bus 730.

Processing device 702 may be provided by one or more general-purpose processing devices such as a microprocessor, central processing unit, or the like. In an illustrative example, processing device 702 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 702 may also include one or more special-purpose processing devices such as an application specific integrated circuit (ASIC), a field programmable gate array (FPGA), a digital signal processor (DSP), network processor, or the like. The processing device 702 may be configured to execute the operations described herein, in accordance with one or more aspects of the present disclosure, for performing the operations and steps discussed herein.

Computing device 700 may further include a network interface device 708 which may communicate with a network 720. Computing device 700 may utilize the network 720 to perform UWB communications for a ranging operation with another device. The computing device 700 also may include a video display unit 710 (e.g., a liquid crystal display (LCD) or a cathode ray tube (CRT)), an alphanumeric input device 712 (e.g., a keyboard), a cursor control device 714 (e.g., a mouse) and an acoustic signal generation device 716 (e.g., a speaker). In one embodiment, video display unit 710, alphanumeric input device 712, and cursor control device 714 may be combined into a single component or device (e.g., an LCD touch screen).

Data storage device 718 may include a computer-readable storage medium 728 on which may be stored one or more sets of instructions 725 that may include enduring action manager 723 for managing enduring actions, in accordance with one or more aspects of the present disclosure. Instructions 725 may also reside, completely or at least partially, within main memory 704 and/or within processing device 702 during execution thereof by computing device 700, main memory 704 and processing device 702 also constituting computer-readable media.

While computer-readable storage medium 728 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

In the above description, some portions of the detailed description are presented in terms of algorithms and symbolic representations of operations on signals or data bits within a non-transitory storage medium. These algorithmic descriptions and representations are the means used by those skilled in the data processing arts to most effectively convey the substance of their work to others skilled in the art. An algorithm is here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

The description includes references to the accompanying drawings, which form a part of the detailed description. The drawings show illustrations in accordance with exemplary implementations. These implementations, which may also be referred to herein as “examples,” are described in enough detail to enable those skilled in the art to practice the implementations of the claimed subject matter described herein. The implementations may be combined, other implementations may be utilized, or structural, logical, and electrical changes may be made without departing from the scope and spirit of the claimed subject matter. It should be understood that the implementations described herein are not intended to limit the scope of the subject matter but rather to enable one skilled in the art to practice, make, and/or use the subject matter.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “controlling,” “processing,” “receiving,” “transmitting,” “obtaining,” “creating,” “determining,” “generating,” “providing,” “maintaining,” “charging,” or the like, refer to the actions and processes of an integrated circuit (IC) controller , or similar electronic device, that manipulates and transforms data represented as physical (e.g., electronic) quantities within the controller's registers and memories into other data similarly represented as physical quantities within the controller memories or registers or other such information non-transitory storage medium.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such.

Implementations described herein may also relate to an apparatus (e.g., an AP or an STA device) having a processor and a memory, with the processor configured to execute instructions stored in the memory for performing the operations herein. This apparatus may be specially constructed for the required purposes, or it may include firmware or hardware logic selectively activated or reconfigured by the apparatus. Such firmware may be stored in a non-transitory computer-readable storage medium, such as, but not limited to, read-only memories (ROMs), random access memories (RAMs), EPROMs, EEPROMs, flash memory, or any type of media suitable for storing electronic instructions. The term “computer-readable storage medium” should be taken to include a single medium or multiple media that store one or more sets of instructions. The term “computer-readable medium” shall also be taken to include any medium that is capable of storing, encoding, or carrying a set of instructions for execution by the machine and that causes the machine to perform any one or more of the methodologies of the present implementations. The term “computer-readable storage medium” shall accordingly be taken to include, but not be limited to, solid-state memories, optical media, magnetic media, any medium that is capable of storing a set of instructions for execution by the machine and that causes the machine to perform any one or more of the methodologies of the present implementations.

The above description sets forth numerous specific details such as examples of specific systems, components, methods, and so forth, in order to provide a good understanding of several implementations of the present disclosure. It is to be understood that the above description is intended to be illustrative and not restrictive. Many other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method, comprising:
determining, by a central anchor of an anchor system, that a first wireless device has initiated an enduring action, the anchor system comprising the central anchor and a secondary anchor, the first wireless device and a second wireless device connected to the central anchor;
processing, using the central anchor, data of the enduring action; and
responsive to processing the data of the enduring action, controlling the central anchor to disconnect from the second wireless device and controlling the secondary anchor to establish a connection with the second wireless device.

2. The method of claim 1, further comprising:
controlling the secondary anchor to determine a priority of a message from the second wireless device.

3. The method of claim 2, wherein the message comprises a remote keyless entry (RKE) message.

4. The method of claim 2, further comprising:
in response to the priority meeting a priority level, controlling the central anchor to suspend a performance of the enduring action to process the message; and
in response to the priority not satisfying the priority level, controlling the secondary anchor to retain the message until the enduring action completes.

5. The method of claim 1, wherein the processing of the data of the enduring action comprises determining that a processing time of the enduring action meets or exceeds a threshold.

6. The method of claim 1, wherein the first wireless device and the second wireless device are connected to the anchor system via a plurality of BLUETOOTH sessions.

7. The method of claim 1, wherein the enduring action comprises an ULTRA-WIDEBAND (UWB) ranging operation.

8. A computing apparatus on a vehicle, the computing apparatus comprising:
a memory;
a transceiver; and
a processing system operatively coupled to the memory and the transceiver, wherein the processing system is configured to:
determine that a first wireless device has initiated an enduring action with an anchor system comprising a central anchor and a secondary anchor, the first wireless device and a second wireless device connected to the central anchor;
control the central anchor to process data of the enduring action; and
responsive to controlling the central anchor to process the data of the enduring action, control the central anchor to disconnect from the second wireless device and control the secondary anchor to establish a connection with the second wireless device.

9. The computing apparatus of claim 8, wherein the processing system is further configured to control the secondary anchor to determine a priority of a message from the second wireless device.

10. The computing apparatus of claim 9, wherein the message comprises a remote keyless entry (RKE) message.

11. The computing apparatus of claim 9, wherein the processing system is further configured to:
in response to the priority meeting a priority level, control the central anchor to suspend a performance of the enduring action to process the message; and
in response to the priority not meeting the priority level, control the secondary anchor to retain the message until the enduring action completes.

12. The computing apparatus of claim 8, wherein, to process the data of the enduring action, the processing system is configured to:
determine that a processing time of the enduring action meets or exceeds a threshold.

13. The computing apparatus of claim 8, wherein the first wireless device and the second wireless device are connected to the anchor system via a plurality of BLUETOOTH sessions.

14. The computing apparatus of claim 8, wherein the enduring action comprises an ULTRA-WIDEBAND (UWB) ranging operation.

15. An anchor system on a vehicle, the anchor system comprising a central anchor and a secondary anchor,
wherein the central anchor is connected to a first wireless device and a second wireless device, and wherein the central anchor is configured to:
determine that the first wireless device has initiated an enduring action;
process data of the enduring action; and
responsive to processing the data of the enduring action, disconnect from the second wireless device, and
wherein the secondary anchor is configured to:
establish a connection with the second wireless device.

16. The anchor system of claim 15, wherein the secondary anchor is further configured to determine a priority of a message from the second wireless device.

17. The anchor system of claim 16, wherein the message comprises a remote keyless entry (RKE) message.

18. The anchor system of claim 16, wherein
in response to the priority meeting a priority level, the central anchor is configured to suspend a performance of the enduring action to process the message; and
in response to the priority not meeting the priority level, the secondary anchor is configured to retain the message until the enduring action completes.

19. The anchor system of claim 15, wherein, to process the data of the enduring action, the central anchor is configured to determine that a processing time of the enduring action meets or exceeds a threshold.

20. The anchor system of claim 15, wherein the central anchor comprises an ULTRA-WIDEBAND (UWB) transceiver, and wherein the enduring action comprises a UWB ranging operation.
